(19) United States
(12) Patent Application Publication
(10) Pub. No.: US 2008/0083039 A1
(43) Pub. Date: Apr. 3, 2008

(54) METHOD FOR INTEGRITY ATTESTATION OF A COMPUTING PLATFORM HIDING ITS CONFIGURATION INFORMATION

(76) Inventors: Su Gil CHOI, Daejeon (KR); Sung Ik JUN, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/842,231

(22) Filed: Aug. 21, 2007

(30) Foreign Application Priority Data
Sep. 29, 2006 (KR) 10-2006-0096571

(51) Int. Cl. H04L 9/32

(52) U.S. Cl. 726/27

(57) ABSTRACT

A method for providing integrity attestation while hiding configuration information is provided. At an integrity attestation target system, the method comprises: creating a measurement value by measuring a component related to an event whenever an event influencing the integrity occurs while the computing platform is driven; hiding information which components are related to the created measurement value; recording the hidden measurement value at a PCR with a measurement list including information about all measurement values measured after the platform is driven; receiving an integrity attestation request transferred from an external system; composing data including the hidden measurement value and information for confirming whether the hidden measurement value is created from integrity sustained components; and transmitting the data to the integrity attestation request external system.

### CLAIM OF PRIORITY

This application claims the benefit of Korean Patent Application No. 2006-96571 filed on Sep. 29, 2006, in the Korean Intellectual Property Office, the disclosure of which is incorporated herein by reference.

### BACKGROUND OF THE INVENTION

1. Field of the Invention

The present invention relates to a method for providing integrity attestation while hiding configuration information thereof, which can prevent the configuration information of an attestation target platform from being opened to outside when a computing platform attests to an external system that the integrity of the computing platform is sustained.

2. Description of the Related Art

Trusted Computing Group (TCG), global open standard group, manages six technology work groups (WG) including trusted platform module (TPM), trusted software stack (TSS), a mobile phone (MP), a server specific (SS), and a compliance, and a trusted network connect (TNC) subgroup. The TCG defines standards for computing security.

FIG. 1 is a block diagram illustrating a system providing integrity attestation defined in TCG.

Referring to FIG. 1, the system for attesting the integrity of a computing platform defined in TCG includes an integrity attestation target system 110 and an integrity attestation request system 120. The integrity attestation target system 110 includes an integrity measuring module 111, a platform configuration register (PCR) 112, a measurement record storing unit 113 and an integrity attestation service module 114.

FIG. 2A and FIG. 2B are flowcharts illustrating a method for attesting an integrity defined in TCG, and FIG. 3 is a diagram illustrating a protocol thereof.

Referring to FIG. 2A and FIG. 3, the integrity measurement module 111 creates a measurement value by measuring related component when a predetermined event is generated in the platform of the integrity attestation target system 110 at step S110. Herein, the predetermined event is any event that can influence the integrity of a platform, such as program execution, and update. The component denotes any elements that can influence the integrity of the computing platform. For example, the component may be an operating system, a configuration file, a program, a library, and etc. Particularly, the integrity measurement module 111 calculates the hash value of the even that can influence the integrity and the related component at step S120.

The calculated hash value is reflected to the PCR 112 and the measurement record storing unit 113. The PCR 112 is present inside trusted platform module (TPM) which is hardware device for computing system security. The PCR 112 safely stores the order of measuring components and the hash value of the measured component from the integrity measurement module 111 at step S130.

For example, it assumes that the TPM of the integrity attestation target system 110 include only one PCR 112. Under the assumption, if the PCR 112 receives a new hash value, the PCR 112 performs a hash operation on the current PCR value and the new input has value, and updates the PCR value with the newly calculated hash value.

The measurement record storing unit 113 stores the records for all components measured from the integrity measurement module 111 after the platform of the integrity attestation target system 110 starts. Such a stored record is a measurement list. The measurement list includes identification information to identify the component and the hash values of components at step S140.

The steps S110 to S140 shown as (a) in FIG. 2A are repeatedly performed when the events that influence the integrity are occurred in the integrity attestation target system.

When the integrity attestation service module 114 receives an integrity attestation request from an integrity attestation request system 120 to confirm whether the integrity is sustained or not at step S150, related data is prepared and transferred to the integrity attestation request system 120 for verifying the integrity of the integrity attestation target system. Particularly, the integrity attestation request system 200 transmits an integrity attestation request with random number to the integrity attestation target system 110. The integrity attestation service module 114 transfers the random number included in the integrity attestation request to the TPM of the integrity attestation target system 110, thereby requesting the PCR value and the signature. The TPM creates a signature on the random number inputted with the PCR value of the PCR 112, and transfers the created signature and the PCR value to the integrity attestation service module 114 step S160.

The integrity attestation service module 114 transmits the data that can verify the integrity, the signature transferred from the TPM, the PCR value, a certification including a key that can signature, and the measurement list stored in the measurement record storing unit 113 to the integrity attestation request system 120.

Referring to FIGS. 2B and 3, the integrity attestation request system 120 transmits an integrity attestation request with a random number to the integrity attestation target system 110 at step S210 and receives the response message for the request at step S220.

Then, the integrity attestation request system 120 verifies the integrity of the target system based on the data included in the response message. In order to verify the integrity of the target system 110, a sign for the PCR value is verified at step S230. Then, the PCR value is recomposed using a hash value of component in a measurement list, and it determines whether the recomposed PCR value is matched with the signed PCR value at steps S240 and S250. Then, it inspects whether hash values of components are calculated from the integrity verified components at step S260. After three verifications are passed, it determines that the integrity of the integrity attestation target system 110 is sustained at step S270. If one of the three verifications is not passed, it determines that the integrity of the integrity attestation target system 110 is sustained at step S280.

In the conventional integrity attestation technology defined by TCG, a platform environment of the integrity attestation target system, and installed programs and versions thereof can be detected from the integrity attestation request system. Accordingly, the opened information can be used to attack the integrity attestation target system.

Therefore, there is a demand for a method for attesting the integrity without opening the platform information of a target system to external systems.

In order to overcome problems of the conventional technology, a conventional integrity attestation method was introduced in US Patent Publication No. 2006-26423, entitled “PRIVACY-PROTECTING INTEGRITY ATTESTATION OF COMPUTING PLATFORM” published on Feb. 2, 2006.

The conventional integrity attestation method has a shortcoming that a request system must have a lot of available PCR values, particularly, numerous PCR values related to the target platform.

Also, the number of exchanging messages between a request system and a target platform for integrity attestation varies according to PCR values provided form the request system. Furthermore, it is difficult to embody the assumption of an integrity attestation request system.

Moreover, since it provides information with condition that at least one of PCR values must be related to a target platform, it can be used to detect the configuration information of a target platform.

### SUMMARY OF THE INVENTION

The present invention has been made to solve the foregoing problems of the prior art and it is therefore an object according to certain embodiments of the present invention is to provide a method for attesting the integrity of a computing platform while hiding configuration information in order to hide the configuration information from an external system when the computing platform attests the integrity thereof to the external system.

Another object according to certain embodiments of the invention is to provide a method for attesting the integrity of a computing platform while hiding the configuration of a computing platform, which can solve a bottle neck problem of a verification server by minimizing a computation amount processed in the verification server while attesting the integrity of the computing platform through the verification server, hide information about a target platform from data transmitted to the verification server, and hide information of a target platform from an external system.

According to an aspect of the invention for realizing the object, there is provided a method for attesting integrity while hiding configuration information of a computing platform at an integrity attestation target system, comprising: creating a measurement value by measuring a component related to an event whenever an event influencing the integrity occurs while the computing platform is driven; hiding information which components are related to the created measurement value; recording the hidden measurement value at a PCR with a measurement list including information about all measurement values measured after the platform is driven; receiving an integrity attestation request transferred from an external system; composing data including the hidden measurement value and information for confirming whether the hidden measurement value is created from integrity sustained components; and transmitting the data to the integrity attestation request external system.

According to another aspect of the invention for realizing the object, there is provided a method for attesting integrity while hiding configuration information of a computing platform at a verification system, including the steps of: storing information about integrity verified components previously; transmitting an integrity attestation request to a target system for confirming the integrity thereof; receiving a response including a hidden measurement value from the target system; verifying whether the hidden measurement value is created from an integrity sustained component of not by comparing the previously stored information and the hidden measurement value; and creating certification data certifying that the integrity of the target system is sustained if the verification is success, and providing the created certification data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a system providing integrity attestation defined in TCG;

FIG. 2A and FIG. 2B are flowcharts illustrating a method for attesting an integrity defined in TCG;

FIG. 3 is a flowchart of an integration attestation in FIG. 2A and FIG. 2B;

FIG. 4 is a block diagram illustrating a system employing a method for attesting integrity of a computing platform according to an exemplary embodiment of the present invention;

FIG. 5A and FIG. 5B are flowcharts illustrating a method for attesting the integrity of the computing platform according to an embodiment of the present invention; and

FIG. 6 is a flowchart illustrating a method for attesting integrity according to an embodiment of the present invention.

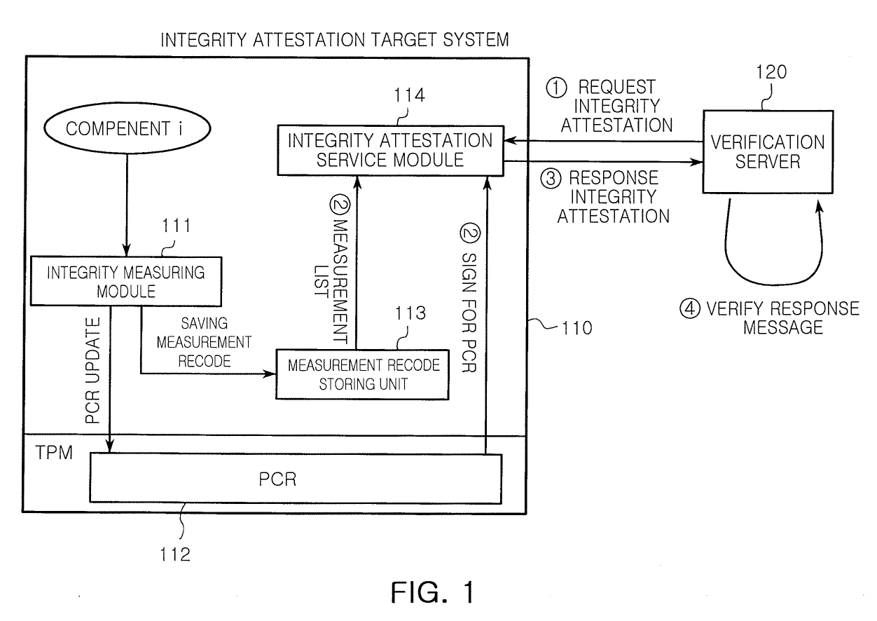

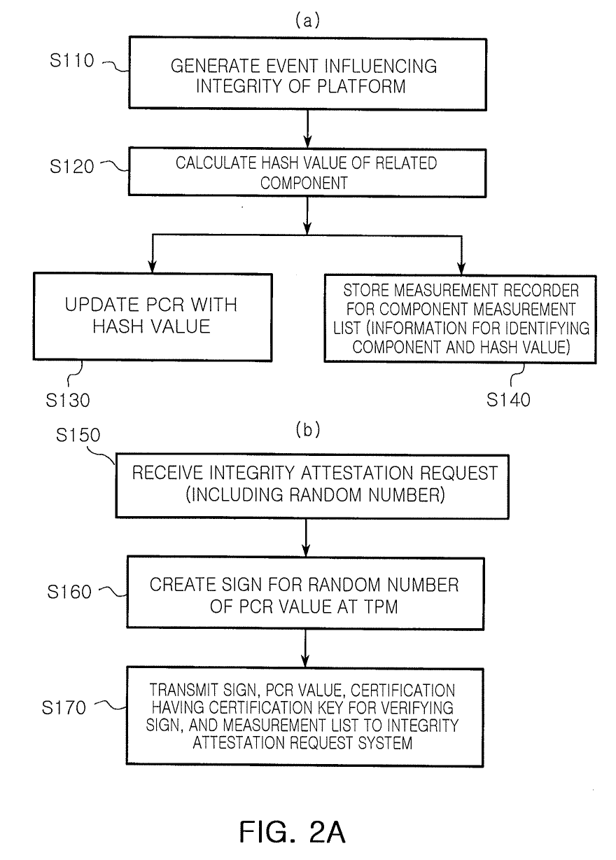

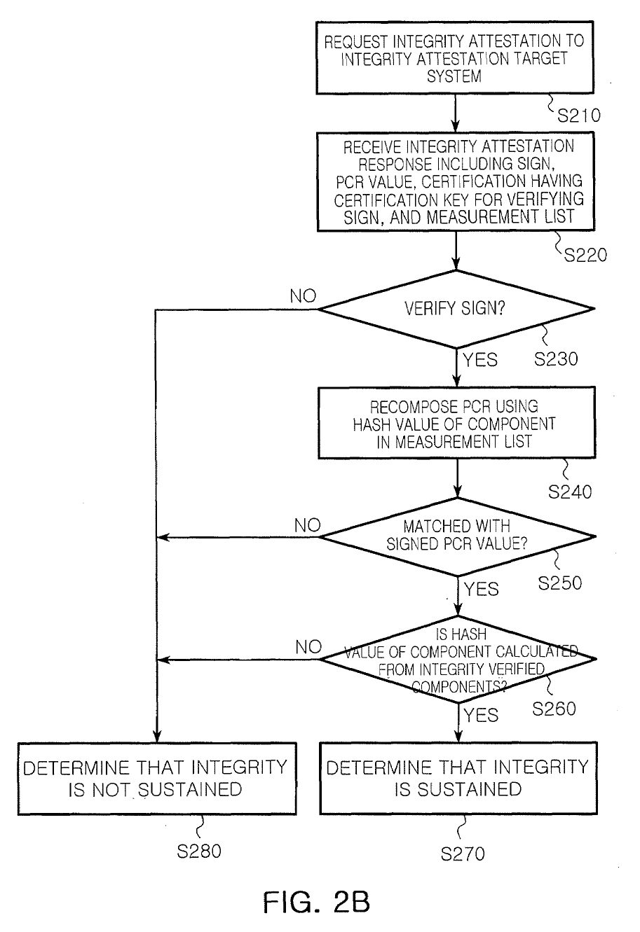

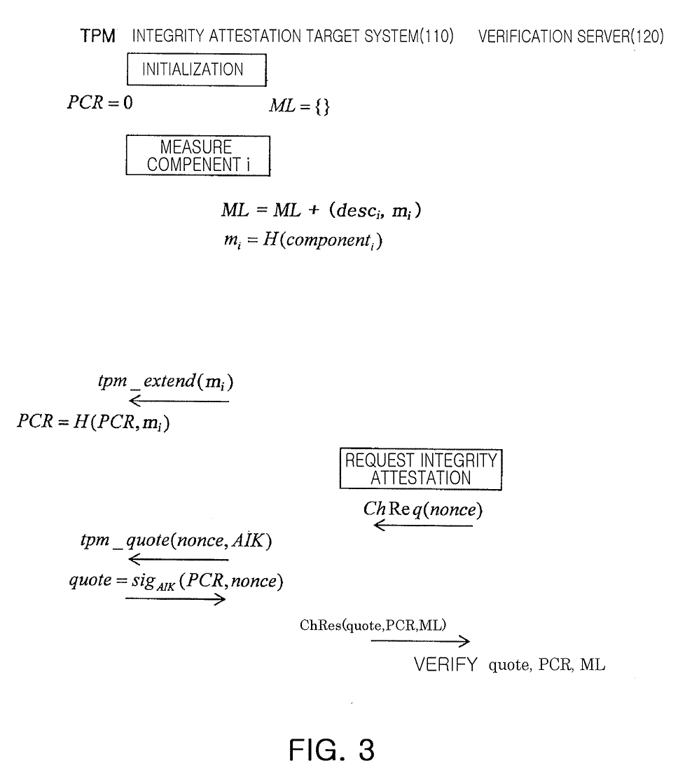

### DETAILED DESCRIPTION OF THE PREFERRED EMBODIMENT

Preferred embodiments of the present invention will now be described in detail with reference to the accompanying drawings.

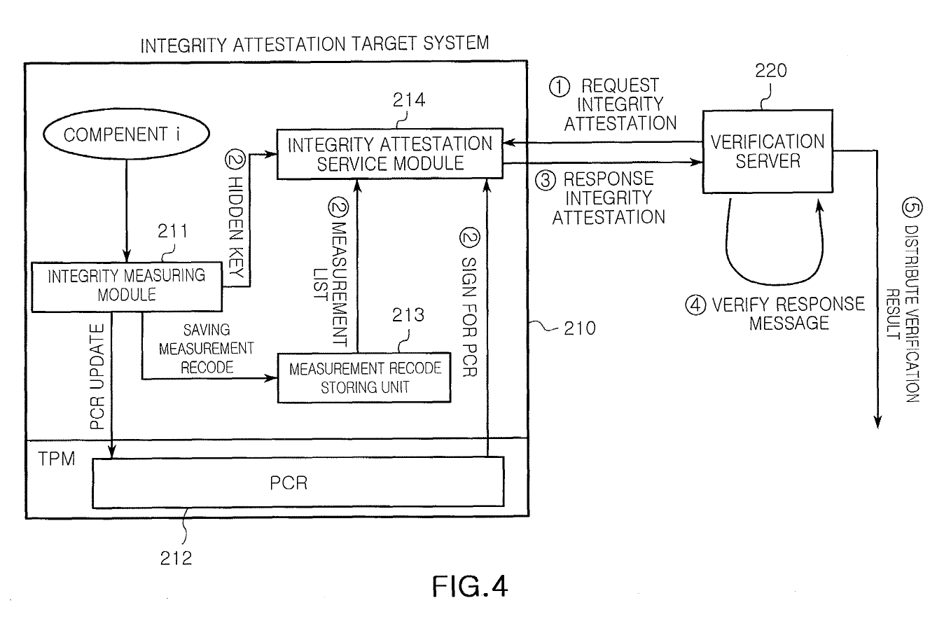

FIG. 4 is a block diagram illustrating a system employing a method for attesting integrity of a computing platform according to an exemplary embodiment of the present invention.

Referring to FIG. 4, the integrity attestation system according to the present embodiment includes an integrity attestation target system 210 for providing data to verify integrity, which is hidden to prevent related component from being opened, in response to an integrity attestation request, and a verification server 220 for requesting integrity attestation to the integrity attestation target system 210, verifying the integrity of the target system 210 after releasing the hidden data obtained therefrom, and providing the verification result to the other external system.

That is, the integrity attestation request and verification thereof are performed through the verification service 220, and then, the verification result is distributed to other systems that confirm the target system 210.

The integrity attestation target system 210 includes an integrity measuring module 211, a PCR 212, a measurement record storing unit 213 and an integrity attestation service module 213, as like that defined in TCG. However, the functions of these constitutional elements are newly defined to protect the configuration information of a platform.

In more detail, the integrity measuring module 211 creates measurement values by measuring component related to events that influences the integrity when the events are occur. The measurement value is hidden not to open information about components that form the measurement value. The hidden measurement value reflects to the PCR 212 and the measurement record storing unit 213. Also, the integrity measuring module 211 provides a hidden key to the integrity attestation service module 214. The hidden key is a parameter used to hide the measurement value.

The PCR 212 receives and stores a new hidden measurement value from the integrity measurement module 211. The PCT 212 performs a hash calculation on the recorded PCR value and the newly input hidden measurement value, and updates the recorded PCR value with the result of the hash calculation.

The measurement record storing unit 213 stores the hidden measurement value with information for identifying the hidden measurement value in an order of inputting the hidden measurement value.

The integrity attestation service module 214 provides data to attest the integrity to the verification server 220 in response to the integrity attestation request from the verification server 220. When the data is provided, the integrity attestation service module 214 also provides a measurement list stored in the measurement record storing unit 213, a PCR value recorded in the PCR 212, a sign for the PCR value, a certification including a key verifying the sign, and a hidden key which is an encoded parameter to confirm the integrity of the component from the hidden measurement value.

According to the present embodiment, since the component information related to the measurement value is hidden in the data transferred to the verification server 220, the other systems cannot obtain the platform configuration of the target system 210 except the target system 210.

The verification server 220 must have information about the integrity verified components previously in order to confirm whether the integrity of the target system 210 is sustained or not from the data from the integrity attestation service module 214. The verification server 220 determines whether the integrity is sustained or not by verifying the sign for the transmitted data and the PCR value, and verifying the hidden measurement value is made of integrity sustained components using the information about integrity verified components. If the integrity is sustained, the certification data is distributed to other systems. The verification server 220 uses the hash value of each component to identify the component of the hidden measurement value because the probability that the hash values of two components are identical is very low. In order to increase a process speed, the hash value of the component is processed. The hash value processing will be described in more detail later.

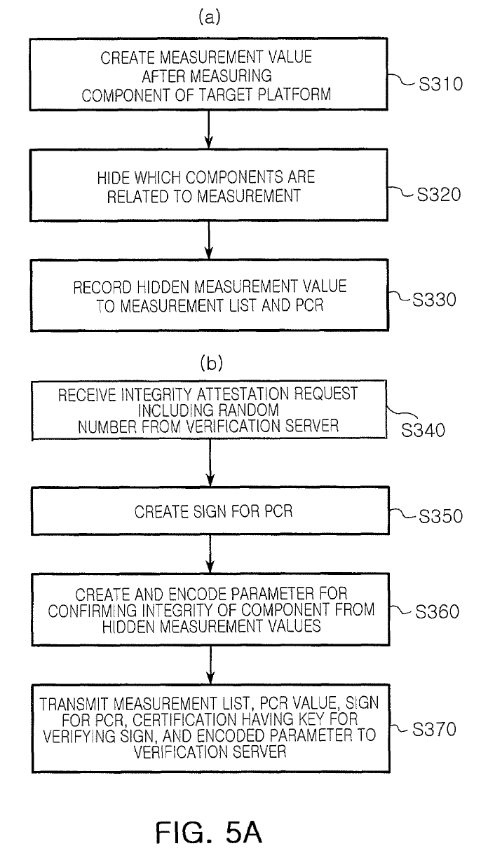

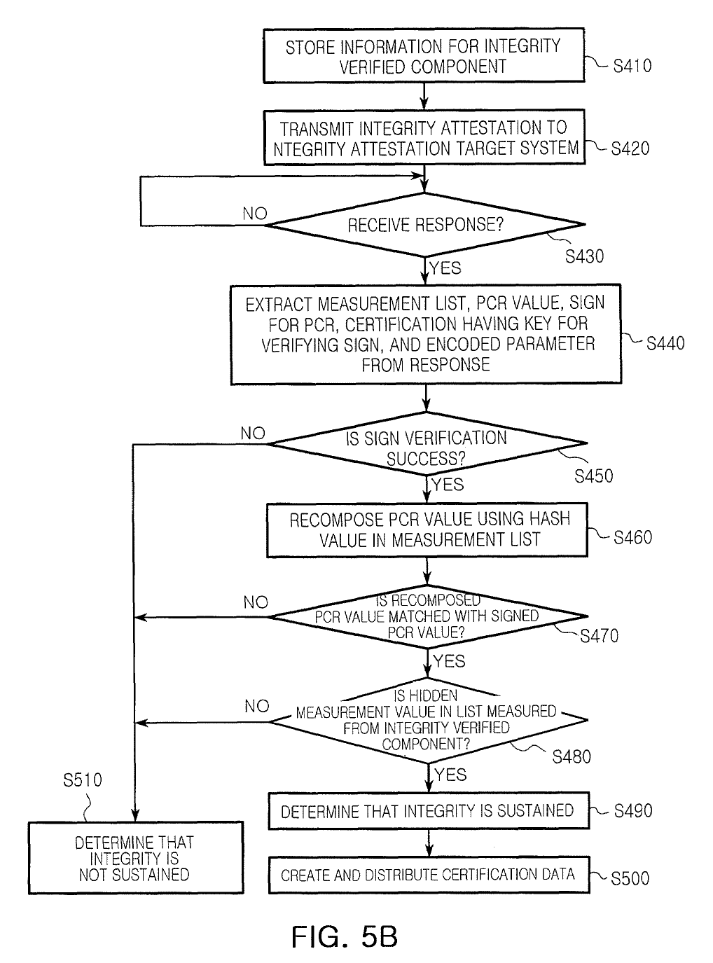

FIG. 5A and FIG. 5B are flowcharts illustrating a method for attesting the integrity of the computing platform according to an embodiment of the present invention. The method for attesting the integrity according to the present embodiment is embodied through the integrity attestation target system 210 and the verification server 220. FIG. 5A shows an integrity attestation method in the integrity attestation target system 210, and FIG. 5B shows an integrity attestation method in the verification server.

Referring to FIG. 5A, whenever an event influencing the integrity occurs in the computing platform, the integrity attestation target system 210 measures components related to an event and creates the measurement value at step S310. As described above, the measurement value may be created by performing a hash calculation on the related component. Furthermore, it is preferable to record the components having the identical hash value, which is created when the measurement value is created, once. The integrity measurement module 211 creates the measurement value.

In order to prevent the configuration information of the computing platform from being opened in the integration attestation step, it hides components that the created measurement value is made of at step S320. At the step S320, the measurement value is transformed to hide the components information of the created measurement value. Herein, a variable generated using a random value is used. The hiding method will be described in detail in later.

Afterward, the hidden measurement value is stored in the measurement list that stores information about all measurement values measured after the platform starts, and a PCR value is recorded in TPM at step S330.

The steps S310 to S330 are performed when events influencing the integrity occur after the computing platform starts and until the computing platform is terminated, and collects information to attest the integrity of the integrity attestation target system 210.

When the integrity attestation target system 210 receives the integrity attestation request including a random number from the verification server 220 at step S340, the integrity attestation target system 210 creates a sign for PCR value stored until now using the PCR value at step S350. That is, the integrity attestation service module 214 provides the integrity attestation request including the random number, which is provided from the verification server 220, to the TPM, and the TPM creates the sign for the PCR value.

Furthermore, the integrity attestation target system 210 creates a parameter for the verification server 220 to confirm whether the hidden measurement value is created from the verified components or not, and encodes the created parameter in order to be recognized by the verification server only at step S360. Since the integrity attestation target system is protected by hiding information about components forming the measurement value in the present embodiment, the verification server 220 does not confirm which components form the hidden measurement value. That is, the verification server 220 confirms whether the hidden measurement value is generated from the integrity verified components or not, and the verification server 220 provides the related information for confirming through the step S360.

When the data for verifying the integrity are prepared from the verification server 220, the integrity attestation target system 210 transmits the prepared data to the verification server 220 for the verification server 220 to verify the integrity of itself at step S370. The data transferred to the verification server for attesting the integrity includes a measurement list, a PCR value, a sign for the PCR value, a certification including a key for confirming the sign, and an encryption value of a hidden parameter for confirming whether the hidden measurement value is created from the integrity verified components or not. As described above, the measurement list includes hidden measurement values and information for identifying each of the hidden measurement values. Whenever the hidden measurement value is created, the PCR value is updates with a value generated by performing a hash operation on the previous PCR value with the created hidden measurement value.

The verification server 220 attests the integrity of the target system 210 from information formed of hidden measurement value transferred from the integrity attestation target system 210 as shown in FIG. 5B.

Referring to FIG. 5B, at step S410 the verification server 330 previously stores information about integrity verified components to verify the integrity by confirming the hidden measurement value is created from the integrity verified components instead of confirming whether related components are searched from the hidden measurement value so as to hide the components. Since the probability that two different components have the same hash value is very low, the hash value of each component is used as information for identifying the component. That is, the verification server 330 previously stores hash values of integrity verified components. Since the verification process for all target systems is concentrated to the verification server 220, the process may be delayed. In order to prevent such a delay, the processing speed must increase. In order to increase the processing speed, it is preferable that the hash value of each component is modified through an additional process without storing the hash value of each component as it is.

After storing the previous information as described above, the verification server transmits an integrity attestation request to corresponding integrity target system 210 when the integrity attestation is required for a predetermined target system at step S420. The integrity attestation request includes a random number set by the verification server 220 for generating a sign for the PCR value. The random number is used to verify the sign for the PCR value transmitted from an integrity attestation target system 210.

When the verification server 220 receives the response from the integrity attestation target system 210, the verification server 220 extracts data for verifying the integrity from the received response message at step S440. That is, the verification server 220 extracts the measurement list, the PCR value, the sign for the PCR value, the certification including a key for confirming the sign, and the encrypted parameters from the received response, which were transferred from the integrity attestation target system 210 previously.

Then, the verification server 220 verifies the extracted data. At first, the verification server 220 verifies the sign for the PCR value at step S450. Then, the verification server 220 recomposes the PCR value using the values of the measurement list and verifies whether the recomposed PCR value is identical to the extracted PCR value at steps S460 and S470. After decoding the encoded parameter, the hidden measurement value in the measurement list is transformed using the encoded parameter, and the hidden measurement value is created from the integrity verified components or not by comparing the transformed value with the integrity verified component at step S480.

If three verifications are all success, the verification server 220 determines that the integrity of the target system 210 is sustained at step S490. If at least one of the three verifications is failed, the verification server 220 determines that the integrity of the integrity attestation target system 210 is not sustained at step S510.

When the verification server 220 determines that the integrity of the target system 210 is sustained, the verification server 220 creates certification data for certifying that the integrity of the target system 210 is sustained so as to open this information to the other external system at step S500. The certification data may include information for identifying an integrity attestation target system and the certification thereof. Also, the certification data may include a certification for a PCR value embodied as the hidden measurement value. The certification data may be formed in various formats.

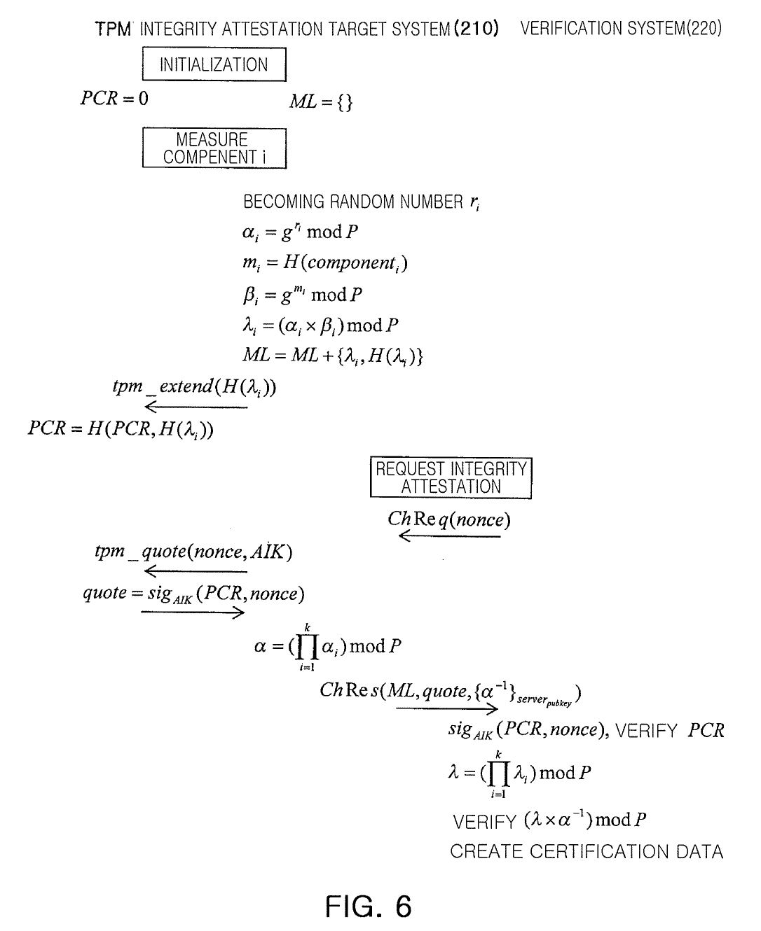

FIG. 6 is a flowchart illustrating a method for attesting integrity according to an embodiment of the present invention.

In this embodiment, it assumes that the verification server 220 and the integrity attestation target system 210 share a large decimal number P and a generator g of a group Z_{P}*. The integrity attestation method according to the present embodiment will be described under that assumption that TPM include only one PCR.

Furthermore, the verification server 220 must have information about integrity verified components previously in order to confirm whether the integrity of the target systems is sustained or not. Among the information, the identification information of each component is embodied by the hash value of the component, and the identification information is modified through additional process for increasing the speed of the verification process as follows.

At the first step, hash values of all of integrity verified components are obtained for known components. That is, if n denotes the number of the integrity verified components, Equation 1 below is calculated.

mⱼ=Hash(componentⱼ) (Equation 1)

where 1≦j≧n, and n is an natural number greater than 1.

At the second step, Bⱼ is calculated for the calculated hash value mⱼ using the shared large decimal number P and the generator g of z_{P}*, as like Equation 2 below.

βⱼ=g^{m}^{ⱼ} mod P (Equation 2)

where a bit text sequence mⱼ is treated as an integer. P is a factor of P−1 according to the definition of discrete logarithm problem and a decimal number q must be larger than the maximum value of when value are treated as large integers.

At the third step, a set (β1, β2, β3, . . . , βn) is obtained by repeating the second step for all components. Then, a feature value for known combinations among combinations made from the elements of the set is calculated through the P. The calculated feature value is stored as the previous information for the integrity verified components. For example, if the elements of a combination is (β1, β3, β7, βn), the feature value of the combination is (β1×β3×β7×βn)mod P. Accordingly, the previous information is prepared for verifying integrity without verifying components from the hidden measurement value.

When the integrity attestation target system 210 is driven by supplying the power thereto, the values for integrity attestation are initialized. For example, the value of PCR 212 is set to 0 and the measurement list variable ML is initialized.

When an event influencing the integrity occurs in the integrity attestation target system 210, the integrity measuring module 211 creates a measurement value of a component related to the corresponding event. When the measurement value is crated, the hash value of the component i is calculated as like equation mᵢ=H(componentᵢ). Then, using the mᵢ and the shared decimal number P, βᵢ=g^{m}^{ⱼ} mod P is calculated. Then, βi is set as the measurement value of the component i. The integrity measuring module 211 stores information about the measured component i. If the corresponding component i is already measured and the hash value thereof does not change, the creation of the measurement value for the corresponding component i is interrupted. That is, the component having an identical hash value is recorded only once.

Although the hash value of the component i is processed to βi using the information shared with the verification server 220 without using the hash value of the component i as it is easy to detect which components are related to the βi, because the P is already opened and the hash value of the component can be calculated by anyone.

In the present embodiment, it hides that the created measurement value is measured from a component i as like the step S320 in FIG. 5A. That is, the integrity measuring module 211 generates a random number ri, calculates a variable αᵢ=g^{r}^{ⱼ} mod P for hiding the measurement value of the component i, and multiplies the calculated measurement value βi to the variable, thereby calculating the hidden measurement value λ₁=(αᵢ×βᵢ)mod p.

After calculating the hidden measurement value, the hidden measurement value λᵢ and the hash value thereof H(λᵢ) are added in the measurement list ML as like ML=ML+{λᵢ,H(λᵢ)}.

Herein, the hash value H(λᵢ) is used as the identification value of the hidden measurement value.

Furthermore, the hash value H(λᵢ) of the hidden measurement value is transmitted to TPM and updates the PCR value. Herein, the updated PCR value is PCR=H(PCR,H(λᵢ)).

Then, when the integrity attestation request (ChReq(nonce)) is received from the verification server 220, the integrity attestation service module 214 prepares data for the verification server 200 to verify the integrity of the target system. That is, a random number (nonce) include in the request is transferred to the TPM of the integrity attestation target system 210, and the TPM creates a sign for a PCR value and a random number as like quote=sig_{AIK}(PCR,nonce)). The integrity measurement module 211 calculates

$$α = ( {\prod }_{i = 1}^{k} {α}_{i} ) mod p$$

for all parameters generated for hiding the measurement values measured until now. Then, the reverse element α⁻¹ of the calculated α, and transferred to the integrity service module 214. Then, the integrity attestation service module 214 encodes the parameter α⁻¹ for the verification server 220. For example, the public key of the verification server 220 is used to encode the parameter α⁻¹.

The integrity attestation service module 214 transmits a response message (ChRes) to the verification server 220 with the PCR value, the sign (quoto) thereof, the measurement list ML, the certification including a key for verifying the sign, and the parameter {α⁻¹}server_{pubkey} for verifying the integrity.

The verification server 220 verifies the sign for the PCR value using the certification, and recomposes the PCR value using the hash value of the hidden measurement values in the ML, and determines whether the signed PCR value is identical to the recomposed PCR value. Then, the verification server decodes the encoded parameter {α⁻¹}server_{pubkey} for confirming whether the hidden measurement values in the ML are calculated from the integrity verified components or not. Then, the verification server 220 calculates

$$λ = ( {\prod }_{i = 1}^{k} {λ}_{i} ) mod p$$

for all hidden measurement values in the ML. Then, using the decode α⁻¹, the feature values (λ×α⁻¹)mod p are calculated for all hidden measurement values in the ML. Then, the calculated feature value is compared with the previously stored information. If one of the previously stored information is matched with the calculated feature value, it determines that the hidden measurement values are calculated from the integrity verified components.

If the verification server 220 confirms that the integrity of the target system 210 is sustained, the verification server 220 creates data that certifies that the integrity of the platform having the PCR value is sustained. Accordingly, the other systems can verify the integrity of the integrity attestation target system 210.

As set forth above, according to preferred (certain) embodiments of the invention, the method for attesting integrity of computing platform hides internal information of a target platform from attackers that taps the communication line as well as an integrity attestation request system. Therefore, the information of the integrity attestation target system is protected from being harmfully used.

Furthermore, the method for attestation integrity of a computing platform according to the present invention minimizes the calculation amount in a verification server while verifying the integrity of a target system through the verification server. Therefore, it prevents the overall processing speed for integrity attestation from being delayed by eliminating the cause of the bottle neck problem in the verification server.

While the present invention has been shown and described in connection with the preferred embodiments, it will be apparent to those skilled in the art that modifications and variations can be made without departing from the spirit and scope of the invention as defined by the appended claims.

What is claimed is:

1. A method for attesting integrity while hiding configuration information of a computing platform at an integrity attestation target system, the method comprising:
creating a measurement value by measuring a component related to an event whenever an event influencing the integrity occurs while the computing platform is driven;
hiding information which components are related to the created measurement value;
recording the hidden measurement value at a PCR (platform configuration register) with a measurement list including information about all measurement values measured after the platform is driven;
receiving an integrity attestation request transferred from an external system;
composing data including the hidden measurement value and information for confirming whether the hidden measurement value is created from integrity sustained components; and
transmitting the data to the integrity attestation request external system.

2. The method according to claim 1, further comprising sharing a decimal number P and a generator g of a group Z_{P}*, which are required for hiding the measurement value and verifying an integrity from the hidden measurement value, with the external system requesting the integrity attestation.

3. The method according to claim 2, wherein in the creating a measurement value, a hash value mᵢ of a corresponding component componentᵢ is calculated as like mᵢ=Hash(componentᵢ), βᵢ=g^{m}^{ᵢ} mod P is calculated using the hash value mᵢ, the decimal number P and the generator g, the calculated, and the βᵢ is used as the measurement value of a corresponding component.

4. The method according to claim 3, wherein the creating a measurement value, the creation of a measurement value is interrupted if a measurement value of components related to an event influencing the integrity had been created, and if the hash value of the component is identical to a previously created hash value.

5. The method according to claim 3, wherein the hiding information includes:
creating a random number ri;
calculating a parameter for hiding measurement values of a corresponding component using the created random number, the shared decimal number and the generator g;
calculating a hidden measurement value by calculating λᵢ=(αᵢ×βᵢ)mod P with a hash value βᵢ of a corresponding component and the parameter.

6. The method according to claim 5, wherein in the recording the hidden measurement value, the hidden measurement value λᵢ and the hash value H(λᵢ) thereof are added in to a measurement list ML.

7. The method according to claim 5, wherein in the recording the hidden measurement value, a hash value H(λᵢ) of the hidden measurement value is hash-calculated with a previous PCR value, and the result thereof is recorded as a new PCR value.

8. The method according to claim 7, wherein in the receiving an integrity attestation request, a random number created from the external system is received with the integrity attestation request.

9. The method according to claim 8, wherein the composing data includes:
creating a sign for a PCR value using the random number received with the integrity attestation request; and
creating a parameter for an integrity attestation request system to confirm whether the hidden measurement value is created from an integrity verified component of not, and encoding the created parameter,
wherein the data is formed of the measurement list, the PCR value, the sign for the PCR, a certification including a key to confirm the sign, and an encryption value of the parameter for confirming whether the hidden measurement value is created from integrity verified components or not for verifying the integrity attestation.

10. A method for attesting integrity while hiding configuration information of a computing platform at a verification system, comprising:
storing information about integrity verified components previously;
transmitting an integrity attestation request to a target system for confirming the integrity thereof;
receiving a response including a hidden measurement value from the target system;
verifying whether the hidden measurement value is created from an integrity sustained component of not by comparing the previously stored information and the hidden measurement value; and
creating certification data certifying that the integrity of the target system is sustained if the verification is success, and providing the created certification data.

11. The method according to claim 10, further comprising sharing a decimal number P and a generator g of a group Z_{P}*, which are required for hiding the measurement value and verifying an integrity from the hidden measurement value, with an integrity attestation target system.

12. The method according to claim 11, wherein the storing information about integrity verified components previously includes:
calculating hash values of all of integrity verified components among known components;
calculating the hash values through βᵢ=g^{m}^{ⱼ} mod P using shared decimal numbers P and a generator g of a group Z_{P}*;
calculating a feature value for a corresponding combination from the calculated values βᵢ for components included in the corresponding combination according to combinations known as existed on a real computing platform among combinations made from the integrity verified components; and
storing the calculated feature values as previous information about the integrity verified components.

13. The method according to claim 12, wherein the feature value of each of the combinations is (βₐ×β_{b}× . . . βₙ)mod P where βₐ, β_{b}, . . . , βₙ denote the values calculating the hash values using shared decimal numbers P and a generator g of a group Z_{P}*) for the components in each combination.

14. The method according to claim 12, wherein in the receiving a response, a measurement list of a corresponding integrity attestation target system, a PCR value, a sign for a PCR value, and an encoded parameter for verifying whether a hidden measurement value is created from integrity verified components are received.

15. The method according to claim 14, wherein the verifying whether the hidden measurement value is created from an integrity sustained component of not comprises:
decoding the encoded parameter;
calculating
$$λ = ( {\prod }_{i = 1}^{k} {λ}_{i} ) mod p or$$
all hidden measurement values in the received measurement list;
calculating a feature value (λ×α⁻¹)mod p of an integrity attestation target system in a measurement list using the encoded parameter and the calculated λ;
determining whether there is previous stored information matched with the calculated feature value or not; and
determining that the hidden measurement values are created from the integrity sustained components if the calculated feature value is matched with at least one of the previously stored information.

16. The method according to claim 15, wherein the verifying whether the hidden measurement value is created from an integrity sustained component of not further comprising:
verifying a sign for the PCR value;
determining that the integrity of a corresponding integrity attestation target system is not sustained if the verification of the sign is fail.

17. The method according to claim 15, wherein the measurement list includes measurement values with entries hidden, and hash values of the hidden measurement values.

18. The method according to claim 17, wherein the verifying whether the hidden measurement value is created from an integrity sustained component of not further comprising:
recomposing a PCR value using the hash value of the measurement list and verifying whether the recomposed PCR value is matched with a PCR value transferred from the integrity attestation target system; and
determining that the integrity of the integrity attestation target system is not sustained if the verification is failed.

19. The method according to the claim 10, wherein the certification data includes information for identifying a corresponding integrity attestation target system and a certification thereof.

20. The method according to claim 17, wherein the certification data includes a certification for a PCR value made of the hidden measurement value.
